(19) United States
(12) Patent Application Publication
(10) Pub. No.: US 2021/0304422 A1
(43) Pub. Date: Sep. 30, 2021

(54) GENERATION OF NON-OCCLUDED IMAGE BASED ON FUSION OF MULTIPLE OCCULDED IMAGES

(71) Applicant: TOSHIBA TEC KABUSHIKI KAISHA, Tokyo (JP)

(72) Inventors: Kevin YU, Epping (AU); Chaminda WEERASINGHE, Bella Vista (AU)

(21) Appl. No.: 16/832,239

(22) Filed: Mar. 27, 2020

(51) Int. Cl. G06T 7/33; G06T 3/00; H04N 5/262

(52) U.S. Cl. CPC G06T 7/33; G06T 3/0068; G06Q 10/087; G06T 2207/20221; G06T 2207/10016; H04N 5/2624

(57) ABSTRACT

A computer-implemented method is for generating a non-occluded image from images that are captured at multiple locations on a plane region parallel to a surface of a target object. Each of the images includes the target object and an occluding object. The images include first and second images. The computer-implemented method includes performing a feature detection on the first image to obtain keypoints in the first image, aligning the first image with a reference image using the obtained keypoints in the first image and keypoints in the reference image, performing the feature detection on the second image to obtain keypoints in the second image, aligning the second image with the reference image using the obtained keypoints in the second image and keypoints in the reference image, and performing a pixel fusion on pixels of the aligned first image and pixels of the aligned second image to generate a fusion image.

### BACKGROUND

A technology of computer vision is widely applied to various uses. Computer vision is a field of technology that trains computers to interpret and understand a visual world using digital images from cameras and/or videos. One particular example of the application is automated inventory management using the computer vision technology. For example, images of a tag (e.g., price tag) located in association with a particular kind of inventory items are captured for a computer vision program to identify the particular kind of inventory items, and also images of the inventory items are captured to recognize the inventory status (e.g., stock quantity) of the items. However, a target object to be captured in images using the computer vision may not be necessarily free from occlusion. That is, an occluding object may hinder view of the target object from a camera, and therefore all necessary information needed for the computer vision may not be obtained from a captured image. In such a case, it is desirable for a computer vision program to perform a computer-based reconstruction of a non-occluded image from captured images to achieve the intended purpose.

### SUMMARY

Various embodiments of the present disclosure provide methods, systems, and non-transitory computer readable media for generating a non-occluded image from a plurality of images that are captured at multiple locations on a plane region parallel to a surface of a target object. A computer-implemented method is for generating a non-occluded image from a plurality of images that are captured at multiple locations on a plane region parallel to a surface of a target object. Each of the plurality of images includes the target object and an occluding object that occludes a part of the target object. The plurality of images includes first and second images. The computer-implemented method includes performing a feature detection on the first image to obtain keypoints in the first image, aligning the first image with a reference image using the obtained keypoints in the first image and keypoints in the reference image, performing the feature detection on the second image to obtain keypoints in the second image, aligning the second image with the reference image using the obtained keypoints in the second image and keypoints in the reference image, and performing a pixel fusion on pixels of the aligned first image and pixels of the aligned second image to generate a first fusion image.

In some embodiments, the feature detection is performed in accordance with a scale-invariant feature transform (SIFT). In some embodiments, the method further includes locating a camera at a first position on the plane region to capture the first image with the camera, and moving the camera to a second position on the plane region to capture the second image with the camera. In some embodiments, the first image is captured using a first camera located at a first position on the plane region, and the second image is captured using a second camera located at a second position on the plane region.

Further, various embodiments of the present disclosure also provide methods, systems, and non-transitory computer readable media for identifying character information on a surface of a target object from a plurality of images that are captured at multiple locations on a plane region parallel to the surface of the target object. A computer-implemented method is for identifying character information on a surface of a target object from a plurality of images that are captured at multiple locations on a plane region parallel to the surface of the target object. Each of the plurality of images includes the target object. The plurality of images includes first and second images. The computer-implemented method includes performing an occlusion detection to determine whether or not at least part of the text information on the surface of the target object in the first image is occluded by an occluding object, performing the occlusion detection to determine whether or not at least part of the text information on the surface of the target object in the second image is occluded by an occluding object, upon determining that the character information is occluded in each of the first image and the second image, performing an occlusion removal to generate a non-occluded image at least based on the first image and the second image, and performing an character recognition on the non-occluded image to identify the character information.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 illustrates an example of an object identification system implemented in an environment including a target object to be identified and an occluding object according to some embodiments;

FIG. 2 illustrates an example of a configuration of an image processing module applicable to an object identification system, according to some embodiments;

FIG. 3 is a flowchart of an example of a computer-implemented method for identifying character information on a surface of a target object according to some embodiments;

FIG. 4 is a flowchart of an example of a computer-implemented method for performing occlusion detection according to some embodiments;

FIG. 5 is a flowchart of an example of a computer-implemented method for performing occlusion removal according to some embodiments;

FIG. 6 schematically illustrates an example of occluded images and a non-occluded image generated based on fusion of the occluded images, according to some embodiments;

FIGS. 7A, 7B, and 7C schematically illustrate another example of occluded images and a non-occluded image generated based on fusion of the occluded images, according to some embodiments, where FIG. 7A illustrates occluded images, FIG. 7B illustrates aligned occluded images, and FIG. 7C illustrates a non-occluded image; and

FIG. 8 is a block diagram illustrating hardware configuration of a computer system upon which any applicable components of an object identification system or an image processing module described herein may be implemented.

### DETAILED DESCRIPTION

A claimed solution rooted in computer technology overcomes problems specifically arising in the realm of computer technology. In various implementations, methods, systems, and non-transitory computer readable media for generating a non-occluded image from a plurality of images that are captured at multiple locations on a plane region parallel to a surface of a target object are provided. According to the methods, systems, and non-transitory computer readable media for generating the non-occluded image, the non-occluded image can be generated at a high speed, while maintaining a sufficient image quality for a computer vision program to recognize necessary information from the non-occluded image. Further, in various implementations, methods, systems, and non-transitory computer readable media for identifying character information on a surface of a target object from a plurality of images that are captured at multiple locations on a plane region parallel to the surface of the target object are provided. According to the methods, systems, and non-transitory computer readable media for identifying the character information, the character information can be identified with higher accuracy, which enables a more reliable system based on computer vision.

In this disclosure, “a target object” refers to a physical object including character information on a surface thereof. A “surface” refers to a substantially planar and quasi-Lambertian (i.e., non-glossy) surface. “Occlusion” refers to a state where at least a part of the surface of the target object or at least part of the character information is made non-visible in an image capturing the target object. A “occluding object” refers to a physical or non-physical object that occludes at least portion of the surface or the character information on the target object. “Non-physical object” refers to a shade, a flash, or any other causes that make at least portion of the surface or the character information on the target object non-visible. “Character information” refers to any visible symbols representing letters, numbers, marks, or any other meaningful information.

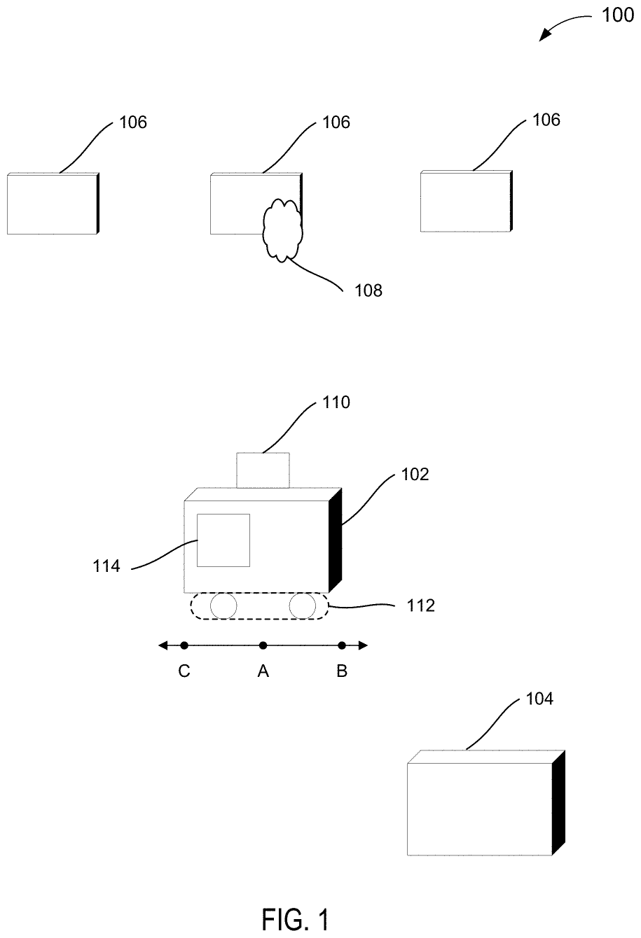

FIG. 1 illustrates an example 100 of an object identification system implemented in an environment including a target object to be identified and an occluding object according to some embodiments. In the example 100 shown in FIG. 1, an object identification system includes an image capturing device 102 and a server 104 that are connected via a network. The object identification system is employed to capture images of target objects 106, some of which view is hindered by an occluding object 108.

The image capturing device 102 is a computing system configured to capture images of a target object 106, generate a non-occluded image based on the captured image, and identify character information on a surface of the target object 106 using the non-occluded image. The computing system may be configured as hardware or a combination of hardware and software. In the example 100 in FIG. 1, the image capturing device 102 includes a camera module 110, and a movement module 112, and an image processing module 114.

The camera module 110 is a computing module configured to capture images of the target objects 106. In some embodiments, when there are a plurality of target objects 106 aligned in a row, the camera module 110 is configured to capture one of the target object 106 in a single image. In a specific implementation, the angle of view of the camera module 110 is configured to capture an image of a single target object 106.

In some embodiments, the camera module 110 includes a single imaging unit to capture image at a location. In some other embodiments, the camera module 110 includes a plurality of imaging units to capture image of a target object 106 from multiple locations. For example, the camera module 110 may includes a first imaging unit at a first location, a second imaging unit at a second location, and a third imaging unit at a third location. The first, second, and third locations may be linearly aligned in a plane region parallel to the surface of the target object 106.

The movement module 112 is a device module configured to move the imaging capturing device 102 in a plane region parallel to the surface of the target object 106. A movement direction of the movement module 112 may be linear or non-linear in the plane region. In some embodiments, the movement module 112 is configured to move horizontally to a first position A, a second position B, and a third position C, such that the camera module 110 can capture images of the target object 106 from the first position A, the second position B, and the third position C. In some embodiments, the movement module 112 is configured to move vertically to multiple position in the similar manner as the horizontal move. In some embodiments, the movement module 112 may include a motor and one or more wheels driven thereby to cause the movement of the image capturing device 102. In a specific implementation, the view of angle of the camera module 110 is fixed (e.g., not panned), so the locations of the target object 106 in the captured images may be shifted when the movement module 112 moves.

The image processing module 114 is a computing module configured to process image data of images captured by the camera module 112. Specifically, the image processing module 114 is configured to perform occlusion detection to determine whether or not an image captured by the camera module 110 is occluded, that is, a target object 106 in the captured image is hindered by the occluding object 108. Further, the image processing module 114 is configured to perform occlusion removal to generate a non-occluded image, which may be a fusion image constructed from pixel fusion of multiple images.

The server 104 is a computing module configured to store data relating to object identification. In some embodiments, the server 104 includes database that stores registered character information to be collated with character information obtained from a captured non-occluded image or a constructed non-occluded image. For example, the character information registered in the database may include character information for identified objects, for which the character information has been matched with the obtained character information, and character information for unidentified objects, for which the character information has not been matched with the obtained character information.

In some embodiments, functionalities of the image processing module 114 may be achieved by the server 104. That is an image processing module may be included as part of the server 104, so the image processing module in the server 104 may perform the functions same as the image processing module 114.

The target objects 106 has character information to be identified on a surface thereof. For example, when the target object 106 is a price tag of a merchandise, the character information may be an identifier and a price of the merchandise.

The occluding object 108 is a physical or non-physical object that hinders view of at least a part of the target object 106. In a specific implementation, the occluding object 108 may be a non-transparent material that completely blocks the view of the part of the target object 106 or may be a semi-translucent material that does not completely block but obscures the view of the part of the target object 106.

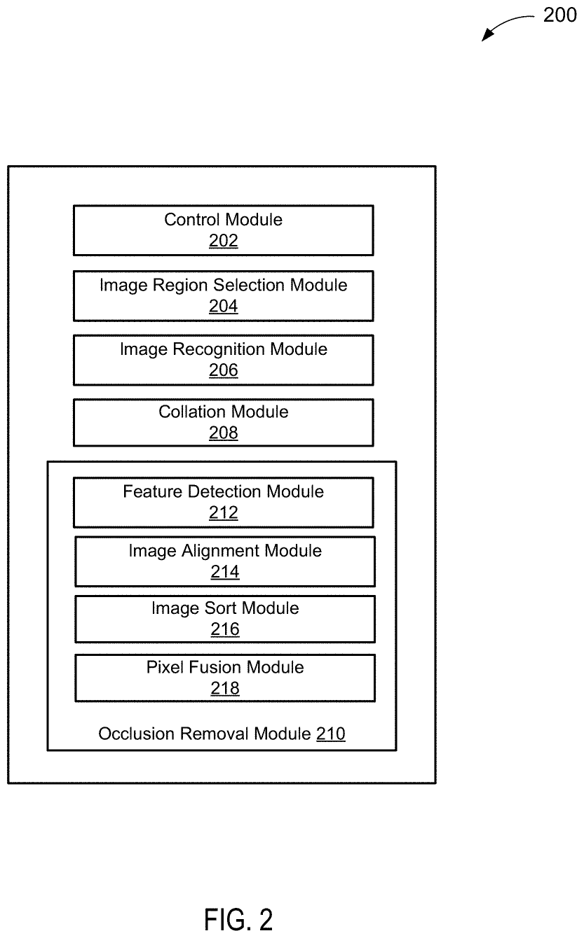

FIG. 2 illustrates an example of a configuration of an image processing module 200 applicable to an object identification system, according to some embodiments.

In the example shown in FIG. 2, the image processing module 200 includes a control module 202, an image region selection module 204, an image recognition module 206, a collation module 208, and an occlusion removal module 210. In some embodiments, the image processing module 200 may correspond to the image processing module 114 in the image capturing device 102 in FIG. 1 or the image processing module in the server 104 in FIG. 1.

The control module 202 is a computing module configured to control and manage the entire operation of the image processing module 200. In a specific implementation, the control module 202 controls the image region selection module 204, the image recognition module 206, and the collation module 208 to perform occlusion detection and identification of character information on a surface of a target object. In another specific implementation, the control module 202 controls the occlusion removal module 210 to perform occlusion removal to obtain a non-occluded image of a target object.

The image region selection module 204 is a computing module configured to extract a region of an image that captures a target object during occlusion detection and/or occlusion removal. The region of the captured image extracted by the image region selection module 204 may be referred to as a region of interest (ROI). The ROI may be a certain horizontal region, a certain vertical region, or a certain rectangular region within the captured image. In a specific implementation, the ROI may be predetermined based on the specific attributes of the target object and may based on a user input that designate the range of the ROI. For example, when the target object is a price tag attached to a shelf of an inventory space at a certain height from a floor, the ROI may be predetermined as a certain height range covering the height of the price tag. In a specific implementation, a specific computer algorithm to determine the ROI based on the attributes of the target object may be employed.

The image recognition module 206 is a computing module configured to perform image recognition with respect to captured images, to obtain character information on a surface of a target object. In a specific implementation, an image subjected to the image recognition may be an entire region of a captured image or a ROI in the captured image. In a specific implementation, the image recognition may involve optical character recognition (OCR). In another specific implementation, an image subjected to the image recognition may be an entire region or a ROI of a non-occluded image constructed by the occlusion removal module 210, which will be described below in more detail.

The collation module 208 is a computing module configured to collate character information obtained by the image recognition module 206 with character information registered in database, such as the database in the server 104 in FIG. 1, to find a matched object. As described above, the character information may be obtained from a captured image or a non-occluded image constructed by the occlusion removal module 210. In a specific implementation, the registered character information may include multiple pieces of character information, each of which corresponds to a registered object, in particular, an unidentified object for which no obtained character information has been matched.

In a specific implementation, based on the result of the collation, the control module 202 can determine whether or not the target object in the captured image is matched with one of registered objects, and therefore whether or not the captured image is occluded. For example, when the obtained character information is “ABCDE,” and one of pieces of the registered character information is also “ABCDE” corresponding to a registered object “X,” then the control module 202 can identify that the object included in the captured image is X, and therefore find that the captured image is not occluded. For example, when the obtained character information is “ADE,” and none of pieces of the registered character information is “ADE,” then the control module 202 can find that the object included in the captured image does not match with any registered objects, and therefore the captured image is occluded. When the captured image is determined to be not occluded, the control module 202 registers the object in the captured image as an identified object.

The occlusion removal module 210 is a computing module configured to perform occlusion removal to generate a non-occluded image from multiple captured images including a target object.

In a specific implementation, the occlusion removal module 210 determines whether or not an image subjected to the occlusion removal is the first image associated with a certain target object to be identified. A specific image processing algorithm to perform such determination, for example, based on transition of histogram of a sequence of captured images, may be employed.

Upon such determination, the occlusion removal module 210 obtains a reference image to be used for the occlusion removal. When the image subjected to the occlusion removal is determined to be the first image for the certain target object, the occlusion removal module 210 selects a template image as the reference image. In a specific implementation, the template image is one of registered images of registered objects for which no character information have not been matched. For example, when no character information obtained by the image recognition module 206 has been matched with “DEFGH” corresponding to a registered object “Y,” a registered image of the registered object “Y” may be used as the reference image. In a specific implementation, a user may designate the template image from the registered images. When the image subjected to the occlusion removal is determined to be not the first image for the certain target object, the occlusion removal module 210 selects a fusion image constructed by the pixel fusion module 218, which will be described in more detail, as the reference image. By using the fusion image, instead of the template image, the lighting and rendering of the target object between the reference image and the occluded image can be virtually identical, which can improve the similarity of the aligned image with the reference image, and also improve the similarity of a resulting fusion image generated by fusion of a previously-generated fusion image.

The occlusion removal module 210 includes a feature detection module 212, an image alignment module 214, an image sort module 216, and a pixel fusion module 218. The feature detection module 212 is a computing module configured to perform feature detection with respect to an occluded image including a target object and an occluding object, to obtain keypoints in the occluded image. Similarly, the occlusion removal module 210 may perform feature detection with respect to the reference image to obtain keypoints in the reference image.

In a specific implementation, the feature detection involves a scale-invariant feature transform (SIFT), which is a feature detection algorithm in computer vision to detect and describe local features in images, or any other applicable feature detection algorithms. In a specific implementation, when the SIFT is employed, keypoints that correspond to a high contrast pixel region, which typically represents a unique feature of the image are determined, and descriptor of the keypoints, which is a spatial histogram of an image gradient in the pixel region. Furthermore, when the keypoints and their descriptors are obtained for the occluded image, the feature detection module 212 may perform optimization of the detected keypoints in the occluded image. To perform the keypoint optimization, the feature detection module 212 may perform matching of the keypoints in the occluded image with keypoints in the reference image; The matching of the keypoints may involve a general search of pixels in the occluded image similar to pixels in the reference image to create a matching pair of pixels between the occluded image and the reference image, and rejection of false pairs among the matched pairs based on a descriptor distance between two pixels less than a certain threshold, to extract truly-matched pairs of pixels.

The image alignment module 214 is a computing module configured to align the occluded image subjected to the feature detection with the reference image using the keypoints in the occluded image and the keypoints in the reference image. In a specific implementation, the image alignment module 214 transforms (e.g., translated, rotated, enlarged, and/or shrunk) the keypoints in the occluded image obtained by the occlusion removal module 210 so as to holographically match the keypoints in the reference image, and reconstructs the occluded image according to the transformed keypoints.

In a specific implementation, among the keypoints obtained by the feature detection module 212, some keypoints that can be used for the image alignment are selected using a random sample concensus (RANSAC) strategy. More particularly, multiple co-linear keypoints, which should be maintained as co-linear keypoints even after any projective transformation of the keypoints, are selected among the obtained keypoints. Then the selected keypoints are holographically transformed to match the corresponding keypoints of the reference image.

The image sort module 216 is a computing module configured to perform sorting of aligned occluded images. In a specific implementation, the occlusion removal module 210 counts the number of aligned occluded images that are accumulated for pixel fusion, and upon the number reaching a predetermined number, causes the image sort module 216 to sort the accumulated aligned occluded images based on a predetermined index indicative of a similarity with the reference image. The predetermined number may be two, or three or more. For example, the predetermined index for an occluded image with a larger area of occlusion may indicate a lower similarity to the reference image than an occluded image with a smaller area of occlusion. As a result of the sorting, the image sort module 216 may sort the aligned occluded images in the order of the degree of occlusion. In a specific implementation, the predetermined index may be a structural similarity index (S SIM).

Further, the image sort module 216 is configured to select a part of the aligned occluded images in a descending order of the similarity with the reference image according to the value of the predetermined index. In a specific implementation, when the reference image is a template image, the image sort module 216 may select a predetermined plural number (e.g., two or more) of the aligned occluded images in the order. In another specific implementation, when the reference image is a fusion image, the image sort module 216 may select a predetermined number (e.g., one, or two or more) of the aligned occluded images as an image to be fused with the fusion image.

The pixel fusion module 218 is a computing module configured to perform pixel fusion with respect to one or more aligned occluded images with one or more aligned occluded image or with the reference image, to generate a fusion image. More specifically, for example, when the pixel fusion module 218 performs pixel fusion with respect to a first aligned occluded image with a second aligned occluded image, the pixel fusion module 218 performs fusion of pixels of the first aligned occluded image with pixels of the second aligned occluded image. Depending on a specific implementation of the embodiments, the pixel fusion module 218 may perform the pixel fusions with respect to two images at a time or three or more images at a time, to generate a single fusion image.

During the pixel fusion, the pixel fusion module 218 performs identification of pixels of the target object and/or the occluding object in each image subjected to the pixel fusion. In some embodiments, during the pixel fusion, the pixel fusion module 218 identifies, from each image subjected to pixel fusion, pixels corresponding to a target object. In a specific implementation, when the target object is a chromatically monotonous object, such as a price tag with text print on a single-color background, the pixels corresponding to the target object can share the same content (e.g., white color). By clustering a group of pixels that share the same content into cliques, the pixel fusion module 218 can identify an approximate contour of the target object in each image.

In some embodiments, during the pixel fusion, the pixel fusion module 218 identifies, from each image subjected to pixel fusion, pixels corresponding to an occluding object. In a specific implementation, when the target object is a chromatically non-monotonous object, the pixels corresponding to the occluding object can be isolated points having various colors. By clustering pixels do not share the same content into cliques, the pixel fusion module 218 can identify an approximate contour of the occluding object in each image.

In some embodiments, during the pixel fusion, the pixel fusion module 218 identifies, from each image subjected to pixel fusion, pixels corresponding to a target object and pixels corresponding to an occluding object. In a similar manner to the above processes to identify the pixels corresponding to a target object and pixels corresponding to an occluding object, the pixel fusion module 218 can identify approximate contours of the target object and the occluding object.

Depending on a specific implementation of the embodiments, the pixel fusion module 218 may perform the identification of the pixels of the target object and the pixels of the occluding object in any applicable color space, such as a red-green-blue (RGB) color space and an hue-saturation-value (HSV) color space.

In addition, in a specific implementation of the embodiments, the image to be subjected to the pixel fusion preferably has less pixels corresponding to neither the target object nor the occluding object, to avoid such pixels from being identified as one of the target object or one of the occluding object. To achieve such result, the image is captured or the ROI may be determined such that the pixels of the target object share more than 50% of the entire pixels of the image subjected to the pixel fusion.

In a specific real-world environment, pixels corresponding to neither the target object nor the occluding object may be clustered into one or more cliques (may be referred to as pseudo-dense cliques) in a similar manner as the pixels corresponding to the target object. Such pseudo-dense cliques, however, tend to be less dense than the clique corresponding to the target object in pixel distribution characteristics in an applied color space. To obtain the clique corresponding to the target object separate from the pseudo-dense cliques, a variance threshold to cut off low-density cliques, which may be determined based on a root mean square error (RMSE), may be employed.

After identification of the pixels of the target object and/or the occluding object, the pixel fusion module 218 performs consolidation of pixels of the images subjected to the pixel fusion. In some embodiments, the pixel fusion module 218 performs the consolidation of pixels, such that an area of pixels corresponding to the target object becomes maximum. In some embodiments, the pixel fusion module 218 performs the consolidation of pixels, such that an area of pixels corresponding to the occluding object becomes minimum.

As a result of the consolidation of pixels, the pixel fusion module 218 constructs a fusion image. Depending on a specific implementation, a value of pixel in the fusion image may exactly corresponding to a corresponding pixel of one of the images subjected to the pixel fusion or an average value (e.g., weighted average) of the corresponding pixel of the images subjected to the pixel fusion. The constructed fusion image potentially has no pixels corresponding to the occluding object and character information on a surface of a target object may completely appear.

The occlusion removal module 210 is further configured to calculate a feature difference between the fusion image constructed by the pixel fusion module 218 and the reference image, and determine whether or not the calculated feature difference is less than a predetermined threshold. The predetermined threshold is selected to achieve that the fusion image with the feature difference less than the threshold has no occlusion to hinder recognition of character information therein. In a specific implementation, the feature difference is indicated by the predetermined index (e.g., SSIM). In a specific implementation, when the feature difference is less than the threshold, the occlusion removal module 210 outputs the fusion image constructed by the pixel fusion module 218 as a non-occluded image. In contrast, in a specific implementation, when the feature difference is not less than the threshold, the occlusion removal module 210 stores the fusion image as a new reference image with which occluded images are to be aligned.

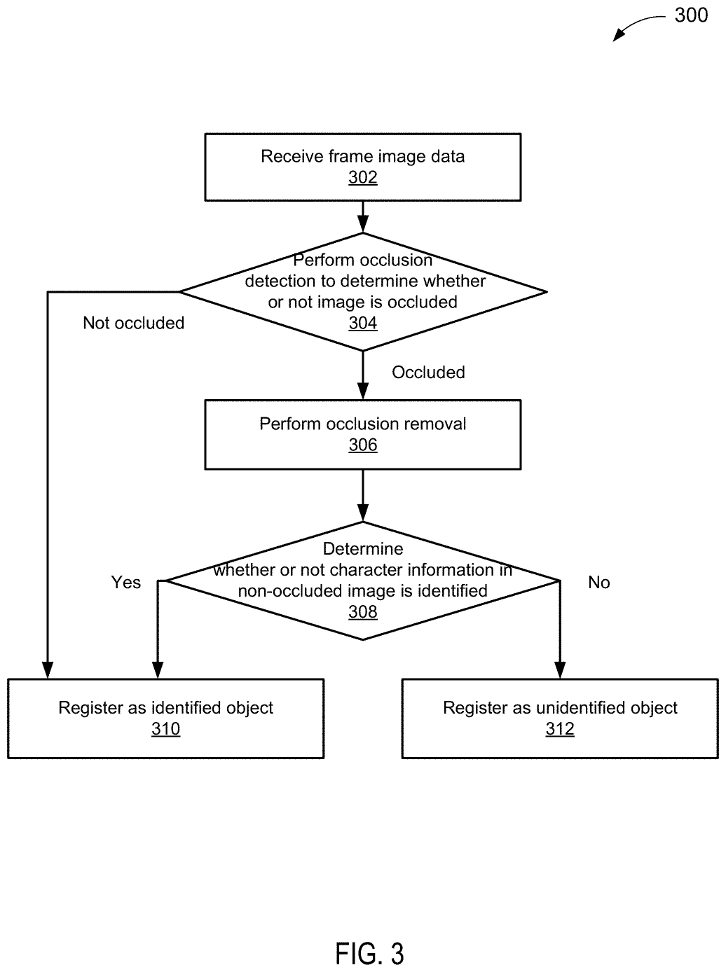

FIG. 3 is a flowchart 300 of an example of a computer-implemented method for identifying character information on a surface of a target object according to some embodiments. This flowchart and the subsequent flowcharts described in the present disclosure illustrate steps organized in a fashion that is conducive to understanding. It should be recognized, however, that the steps can be reorganized for parallel execution, reordered, modified (changed, removed, or augmented), where circumstances permit. In some embodiments, the steps shown in the flowchart 300 are primarily carried out by the image processing device 114 included in the object identification system 100 illustrated in FIG. 1 or the image processing module 200 illustrated in FIG. 2.

In step 302, frame image data is received. In some embodiments, the frame image data corresponds to one of a plurality of frame images captured by one or more cameras at different locations on a plane region parallel to a surface of a target object. Each of the frame images includes the target object, which has character information to be identified on the surface thereof and an occluding object that occludes a part of the character information on the target object. In some embodiments, a module, such as the control module 202 in FIG. 2, receives the frame image data from an applicable source, such as the camera 110 and/or the server 104 in FIG. 1.

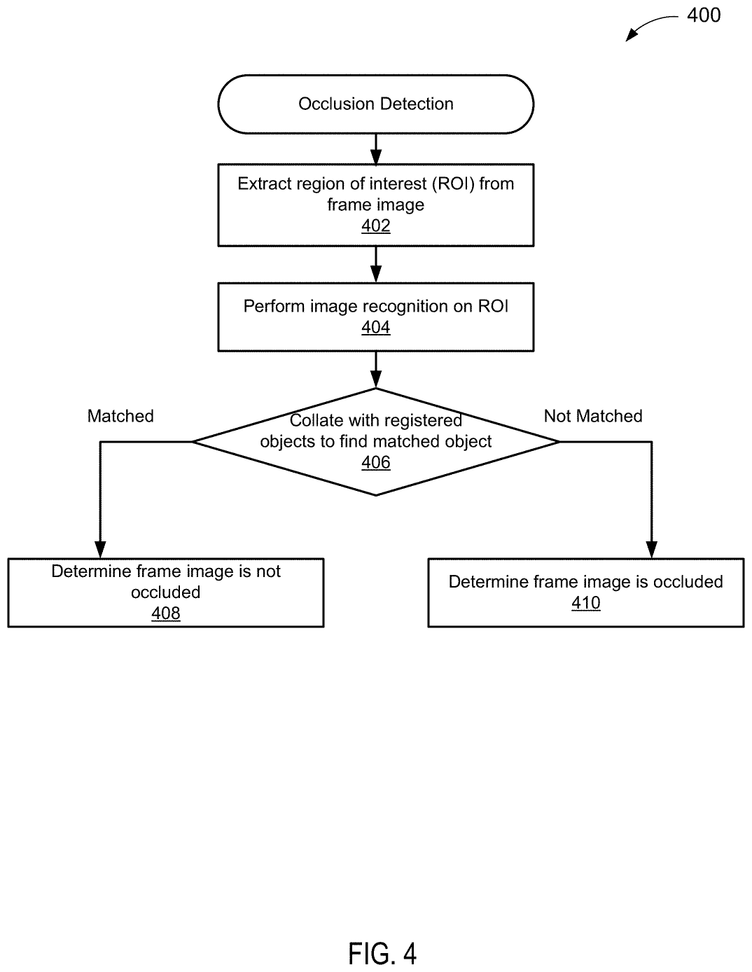

In step 304, occlusion detection is performed to determine whether or not a frame image corresponding to the frame image data received in step 302 is occluded. In some embodiments, the frame image is determined to be occluded when character information obtained from the frame image does not match any character strings registered to database in advance; and the frame image is determined to be not occluded when the obtained character information matches registered character strings. When it is determined that the frame image is occluded (occluded in step 304), the process proceeds to step 306; and when it is determined that the frame image is not occluded (not occluded in step 304), the process proceeds to step 310. A more detailed process of the occlusion detection is described below with reference to FIG. 4. In some embodiments, modules, such as the control module 202, the image region selection module 204, the image recognition module 206, and the collation module 208 in FIG. 2, operate to determine whether or not the frame image is occluded.

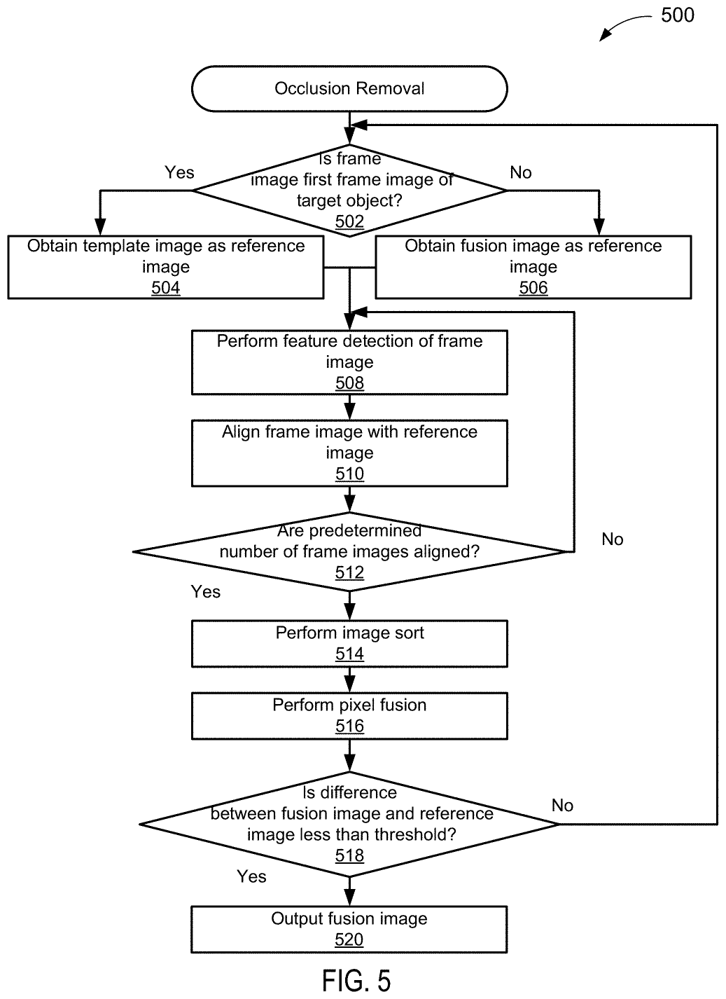

In step 306, occlusion removal is performed to obtain a non-occluded image. The occlusion removal in step 306 is performed with respect to a plurality of frame images that are determined to be occluded in step 304 to obtain the non-occluded image. In a specific implementation, the non-occluded image may expose the entire surface of the target object including the character information thereon. In another specific implementation, the non-occluded image may expose the entire character information thereon, but not the entire surface of the target object. In some embodiments, a module, such as the occlusion removal module 210 in FIG. 2, operates to perform the occlusion removal. A more detailed process of the occlusion removal is described below with reference to FIG. 5.

In step 308, it is determined whether or not character information on the surface of the target object in the non-occluded image is identified. In some embodiments, a region of interest (ROI) including the target object is extracted from the non-occluded image, and then character image recognition (e.g., OCR) is performed with respect to the ROI of the non-occluded image to obtain character information recognizable from the ROI of the non-occluded image. Further, the obtained character information is collated with character strings registered in advance in database to find a matched character string from the character strings. Furthermore, when there is a matched character string, the character information on the surface of the target object is determined to be identified (Yes in step 308); and when there is no matched character string, the character information on the surface of the target object is determined to be unidentified (No in step 308).

When it is determined that the character information is identified (Yes in step 310), the process proceeds to step 310; and when it is determined that the character information is unidentified (No in step 308), the process proceeds to step 312. In some embodiments, a module, such as the control module 202, the image recognition module 206, and the collation module 208 in FIG. 2, cooperatively operate to determine whether or not the character information is identified.

In step 310, the target object with the identified character information is registered as an identified object in database. In some embodiments, when the target object is a specific merchandise, the identified character information, such as an identification code and/or a price of a merchandise, is registered in association with inventory information of the merchandise, which may be obtained from other images that captures a merchandise stock location. In some embodiments, a module, such as the control module 202 in FIG. 2, operates to register the target object with the identified character information as the identified object.

In step 312, the target object with the identified character information is registered as an unidentified object. In some embodiments, the identified character information is registered as character information corresponding to unidentified object (e.g., merchandise). In some embodiments, the non-occluded image of the unidentified object is also registered in database, for example for use a reference image used in the occlusion removal in step 306. In some embodiments, a module, such as the control module 202 in FIG. 2, operates to register the target object with the unidentified character information as the unidentified object.

FIG. 4 is a flowchart 400 of an example of a computer-implemented method for performing occlusion detection according to some embodiments. In some embodiments, the steps shown in the flowchart 400 are primarily carried out by the control module 202, the image region selection module 204, the image recognition module 206, and the collation module 208 illustrated in FIG. 2.

In step 402, a region of interest (ROI) is extracted from the frame image subjected to the occlusion detection. In some embodiments, the ROI is a part of the frame image subjected to the occlusion detection and includes at least the target object. In a specific implementation, when the target object is a price tag placed at a shelf of merchandise, the ROI may be a region at a certain height from a floor ground. In some embodiments, a module, such as the image region selection module 204 in FIG. 2, operates to extract the ROI from the frame image.

In step 404, the image recognition is performed on the ROI of the frame image. In some embodiments, the image recognition involves OCR and character information recognizable from the ROI of the non-occluded image is obtained as a result of the image recognition. In a specific implementation, when the target object is a price tag of a merchandise, the character information may include an identifier (e.g., an identification number or an optical code symbol, such as barcode and QR code, representing the identification) of the merchandise and a price thereof. In some embodiments, a module, such as the image recognition module 206 in FIG. 2, operates to perform the image recognition on the ROI of the frame image.

In step 406, collation is performed to determine whether or not the character information obtained through the image recognition in step 404 is matched with character information of registered objects and find a matched object. In a specific implementation, when the target object is a price tag, an identifier of the merchandise in the obtained character information is collated with identifiers of registered merchandise to find a matched merchandise. For example, when a part of a character string on the surface of the target object is occluded by the occluding object, the obtained character information may lack some part of the character string, and therefore the character information should not match with character information of registered objects. When it is determined that the obtained character information is matched with character information of a registered object (matched in step 406), the process proceeds to step 408; and when it is determined that the obtained character information is not matched with character information of any registered object (not matched in step 406), the process proceeds to step 410. In some embodiments, a module, such as the collation module 208 in FIG. 2, operates to collate the obtained character information with character information of the registered objects to find a matched object.

In step 408, it is determined that the frame image is not occluded. In step 410, it is determined that the frame image is occluded. In some embodiments, a module, such as the control module 202 in FIG. 2, operates to determine whether or not the frame image is occluded based on a result of the collation performed in step 406.

FIG. 5 is a flowchart 500 of an example of a computer-implemented method for performing occlusion removal according to some embodiments. In some embodiments, the steps shown in the flowchart 500 are primarily carried out by the occlusion removal module 210 illustrated in FIG. 2. In some embodiments, the occlusion removal described here may be performed with respect to the ROI of the frame image, which may be obtained through step 402 in FIG. 4, or the entirety of the frame image. Hereinafter, the “frame image” may be referred to either the ROI or the entirety of the frame image.

In step 502, it is determined whether or not the frame image subjected to the occlusion removal is the first image subjected to the occlusion removal. When it is determined that the frame image is the first image (Yes in step 502), the process proceeds to step 504; and when it is determined that the frame image is not the first image (No in step 504), the process proceeds to step 506. In some embodiments, a module, such as the occlusion removal module 210 in FIG. 2, operates to determine whether or not the frame image is the first frame image.

In step 504, a template image is obtained as a reference image. In some embodiments, the reference image is an image including a reference object having a same shape as the target object. In some embodiments, therefore, the template image is an image of an unidentified object that is registered in a database, e.g., at step 312 in FIG. 3. In some embodiments, a module, such as the occlusion removal module 210 in FIG. 2, operates to obtain the template image.

In step 506, a fusion image that has been obtained as a result of pixel fusion (in step 514) is obtained as a reference image. The detail of the fusion image is described below.

In step 508, feature detection of the frame image is performed. In a specific implementation, the feature detection may involve a scale-invariant feature transform (SIFT), and as a result of the feature detection, a plurality of keypoints representing the feature of the frame image is obtained. In some embodiments, a module, such as the feature detection module 212 in FIG. 2, operates to perform the feature detection of the frame image.

In step 510, the frame image is aligned with the reference image obtained at step 504 or step 506. In some embodiments, the keypoints in the frame image in the frame image obtained in step 508 are moved (e.g., translated, rotated, enlarged, or shrunk) to match keypoints in the reference image, to align the frame image with the reference image. In some embodiments, the aligned frame image is stored in an image memory. In some embodiments, a module, such as the image alignment module 214 in FIG. 2, operates to align the frame image with the reference image.

In step 512, it is determined whether or not a predetermined number of frame images are aligned with the reference image. When it is determined that the predetermined number of frame images are aligned (Yes in step 512), the process proceeds to step 514; and when it is determined that the predetermined number of the frame images are not aligned (No in step 512), the process returns to step 508 to perform the feature detection in step 508 and the image alignment in step 510 with respect to an additional frame image including the target object. In some embodiments, the number of image frames stored in the image memory is counted to determine whether or not the predetermined number of frame image are aligned. In some embodiments, the predetermined number may be two, or three or more. In some embodiments, the predetermined number may be different depending on whether the reference image is a template image or a fusion image. For example, when the reference image is a template image, the predetermined number is two or more; and when the reference image is a fusion image, the predetermined number is one, or two or more (e.g., less than when the reference image is a template image). In some embodiments, a module, such as the occlusion removal module 210 in FIG. 2, operates to determine whether or not the predetermined number of frame images are aligned with the reference image.

In step 514, the predetermined number of frame images that have been aligned with the reference image are sorted. In some embodiments, step 514 is optional, for example, when the predetermined number is one or two. In some embodiments, the sorting of the aligned frame image is carried out based on a structure similarity index (SSIM), and a group (e.g., one, or two or more) of the aligned frame images in a descending order of the SSIM are selected for the subsequent process. In some embodiments, a module, such as the image sort module 216 in FIG. 2, operates to sort the aligned frame images.

In step 516, pixel fusion is performed with respect to the selected group of the aligned frame images. In some embodiments, when the reference image is a template image, the pixel fusion is carried out with respect to pixels of each of the selected group (e.g., two or more) to generate a fusion image. In some embodiments, when the reference image is a fusion image, the pixel fusion is carried out with respect to pixels of each of the selected group (e.g., one or more) and to pixels of the fusion image used as the reference image. In a specific implementation, the fusion image may include a first part imported from a first aligned frame image, a second part imported from a second aligned frame image, and a third part imported from a third aligned frame image. In some embodiments, a module, such as the pixel fusion module 218 in FIG. 2, operates to perform the pixel fusion.

In step 518, it is determined whether or not feature difference between the fusion image obtained in step 516 and the reference image is less than a threshold. When it is determined that the feature difference is less than the threshold (Yes in step 518), the process proceeds to step 520. When it is determined that the feature difference is not less than the threshold (No in step 518), the obtained fusion image is registered as a candidate for a reference image to be obtained in step 506, and the process returns to step 502. Therefore, in the second and subsequent iteration of steps 508-518, one of obtained fusion images is used as a reference image. In some embodiments, a module, such as the occlusion removal module 210 in FIG. 2, operates to determine whether or not the feature difference is less than the threshold.

In step 520, the obtained fusion image is output as a non-occluded image of the target object, and the process ends. In some embodiments, a module, such as the occlusion removal module 210 in FIG. 2, operates to output the fusion image as the non-occluded image of the target object.

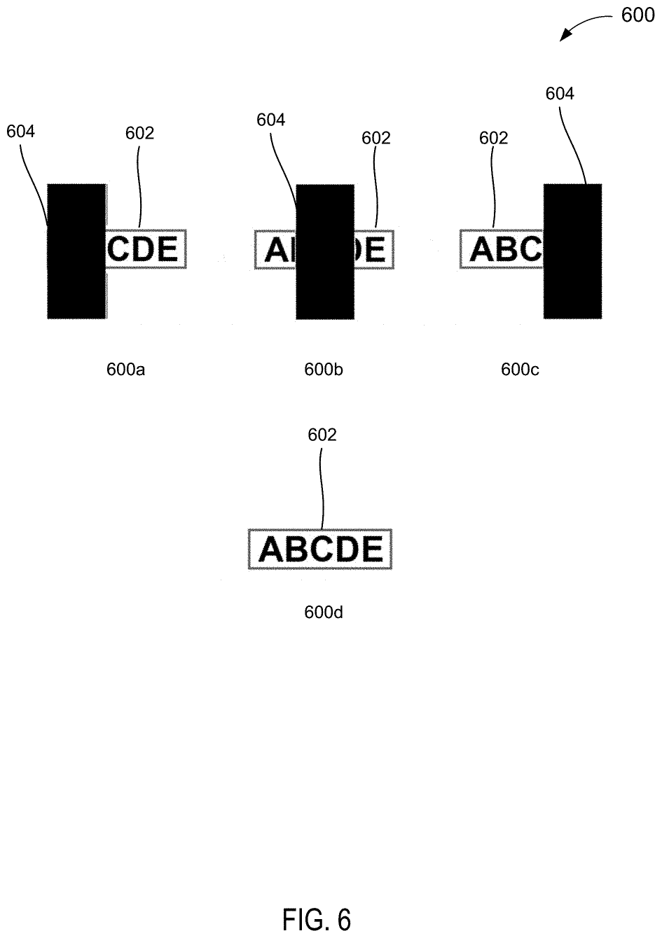

FIG. 6 schematically illustrates an example 600 of occluded images and a non-occluded image generated based on fusion of the occluded images, according to some embodiments. The example 600 in FIG. 6 includes three occluded images 600a, 600b, and 600c, which are captured on a plane region parallel to a surface of a target object 602 including character strings to be identified. Specifically, the occluded image 600a is captured at a first location in the plane region, the occluded image 600b is captured at a second location in the plane region, and the occluded image 600c is captured at a third location in the plane region. The first location is right of the second location, facing the target object 602, and the third location is left of the second location, facing the target object 602. The first, second, and third locations are aligned substantially along a lateral edge of the surface of the target object 602.

In the occluded image 600a, the target object 602, which includes character strings to be identified on the surface, is occluded by an occluding object 604. The occluded image 600a includes a part of the character strings “CDE” on the right of the occluding object 604. In the occluded image 600b, the target object 602 is occluded by the occluding object 604 and a part of the character strings “A . . . E” is visible. In the occluded image 600c, the target object 602 is occluded by the occluding object 604, and a part of the character strings “ABC” is visible on the left of the occluding object 604.

As a result of pixel fusion of pixels of the occluded image 600a, pixels of the occluded image 600b, and pixels of the occluded image 600c, e.g., the pixel fusion described with reference to FIG. 5 (step 514), the non-occluded image 600d can be obtained. The non-occluded image 600d exposes the entire character strings “ABCDE” on the surface of the target object 602.

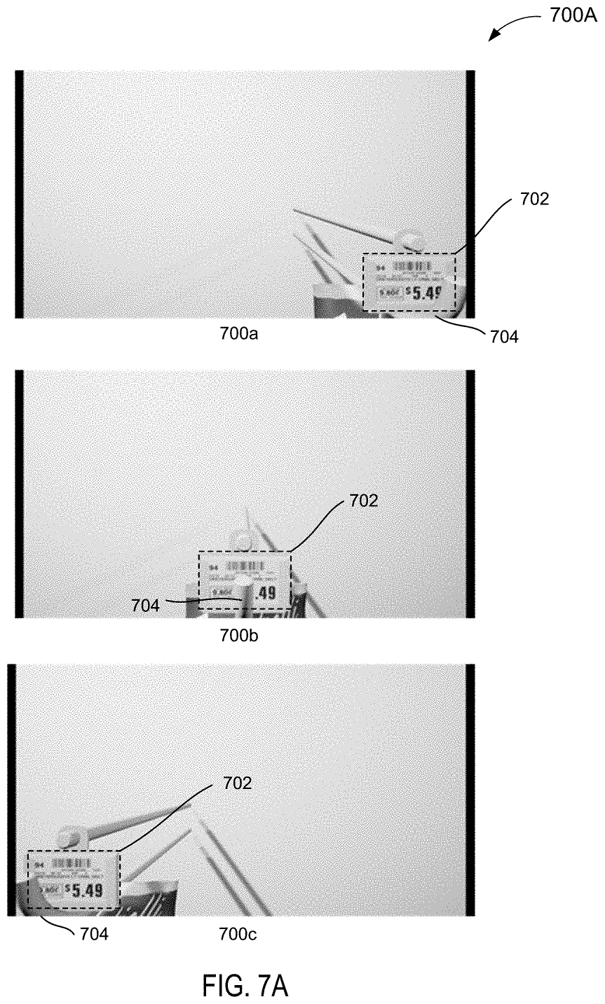

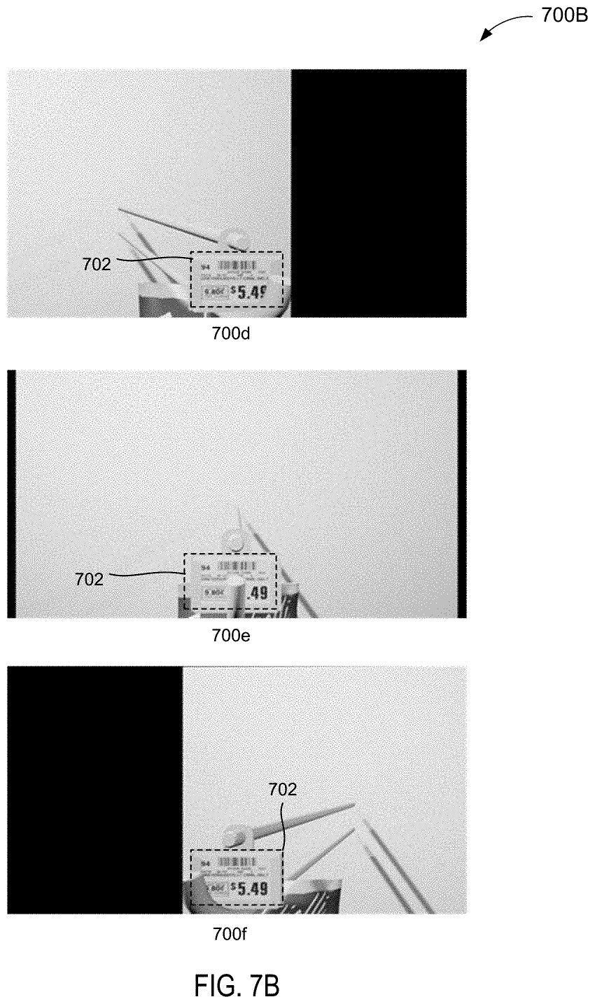

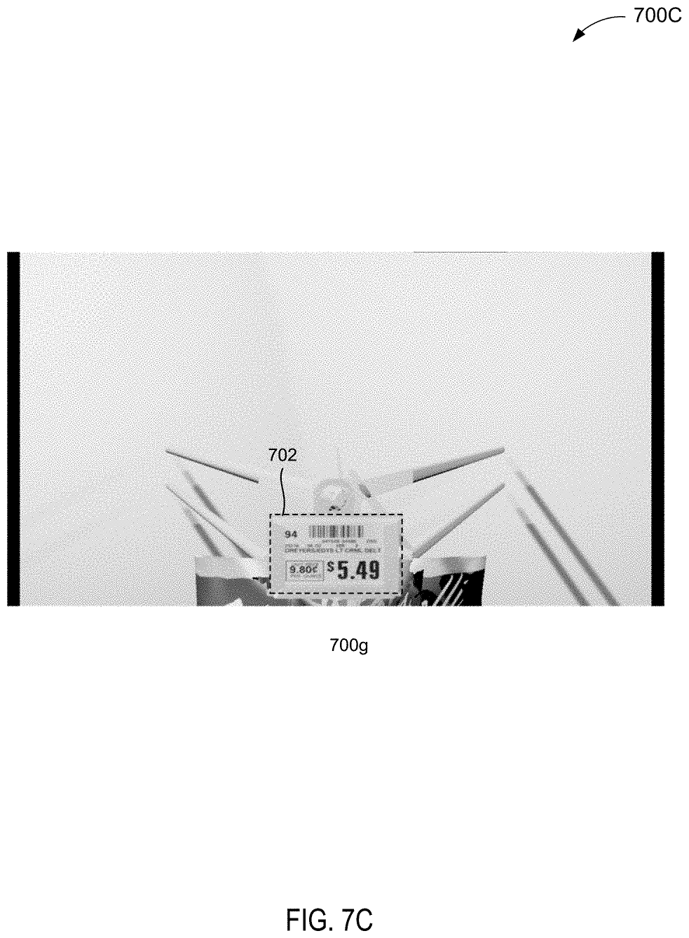

FIGS. 7A, 7B, and 7C schematically illustrate another example of occluded images and a non-occluded image generated based on fusion of the occluded images, according to some embodiments. FIG. 7A illustrates an example 700A of occluded images, FIG. 7B illustrates an example 700B of aligned occluded images, and FIG. 7C illustrates an example 700C of a non-occluded image.

The example 700A in FIG. 7A includes three occluded images 700a, 700b, and 700c, which are captured on a plane region parallel to a surface of a target object 702 including character strings to be identified. Specifically, the target object 702 is a price tag displayed on a retailer and hanging from a price tag holder. The occluded image 700a is captured at a first location in the plane region, the occluded image 700b is captured at a second location in the plane region, and the occluded image 700c is captured at a third location in the plane region. The first location is right of the second location, facing the target object 702, and the third location is left of the second location, facing the target object 702. The first, second, and third locations are aligned substantially along a lateral edge of the surface of the target object 702.

In the occluded image 700a, a target object 702, which includes character strings to be identified on the surface, is occluded by an occluding object 704. Specifically, the occluding object 704 is a curved end of a bar with which a merchandise corresponding to the price tag is held. The occluded image 700a includes only a part of the character strings (e.g., price) on the right of the occluding object 704. In the occluded image 700b, the target object 702 is occluded by the occluding object 704 and only a part of the character strings is visible. In the occluded image 700c, the target object 702 is occluded by the occluding object 704, and only a part of the character strings is visible on the left of the occluding object 704.

As a result of image alignment, e.g., the alignment of images described with reference to FIG. 5 (step 510), three aligned occluded images 700d, 700e, and 700f, which correspond to the occluded images 700a, 700b, and 700c, respectively, are obtained. The locations of the target object 702 in the aligned occluded images 700d, 700e, and 700f are substantially the same and at a center thereof.

As a result of pixel fusion of pixels of the aligned occluded image 700d, pixels of the aligned occluded image 700e, and pixels of the aligned occluded image 700f, e.g., the pixel fusion described with reference to FIG. 5 (step 514), a non-occluded image 700g shown in FIG. 7C can be obtained. The non-occluded image 700g exposes the entire character strings on the surface of the target object 702.

The techniques described herein can be implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

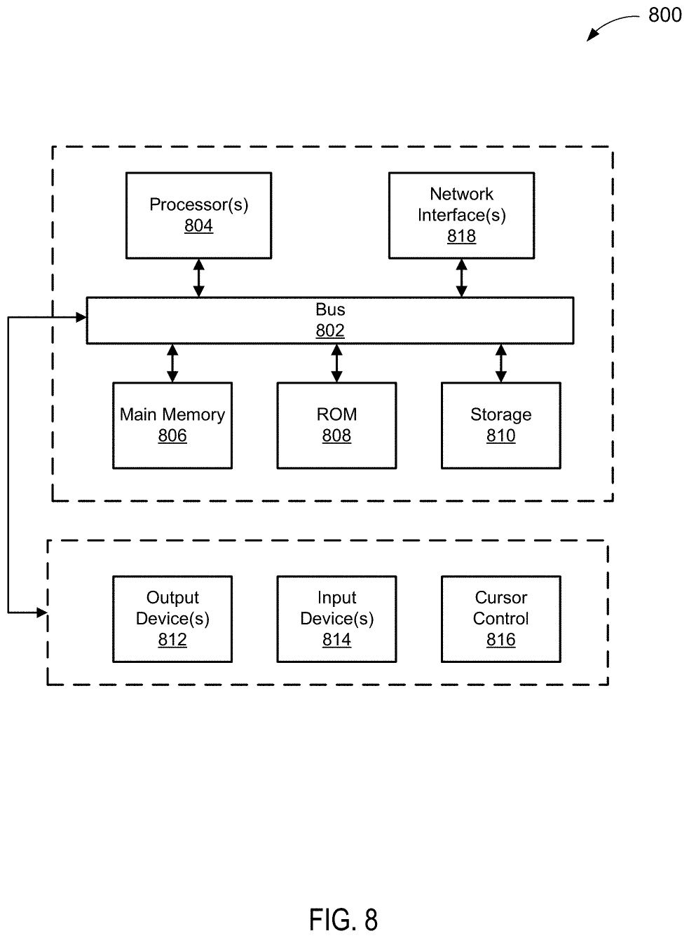

FIG. 8 is a block diagram illustrating hardware configuration of a computer system 800 upon which any applicable components of an object identification system described herein may be implemented. For example, the computer system 800 is applicable to hardware of the object identification system 100 illustrated in FIG. 1. The computer system 800 includes a bus 802 or other communication mechanism for communicating information, one or more hardware processors 804 coupled with bus 802 for processing information. Hardware processor(s) 804 may be, for example, one or more general purpose microprocessors.

The computer system 800 also includes a main memory 806, such as a random access memory (RAM), cache and/or other dynamic storage devices, coupled to bus 802 for storing information and instructions to be executed by processor 804. Main memory 806 also may be used for storing temporary variables or other intermediate information during execution of instructions to be executed by processor 804. Such instructions, when stored in storage media accessible to processor 804, render computer system 800 into a special-purpose machine that is customized to perform the operations specified in the instructions.

The computer system 800 further includes a read only memory (ROM) 808 or other static storage device coupled to bus 802 for storing static information and instructions for processor 804. A storage device 810, such as a magnetic disk, optical disk, or USB thumb drive (Flash drive), etc., is provided and coupled to bus 802 for storing information and instructions.

The computer system 800 may be coupled via bus 802 to a display 812, such as a cathode ray tube (CRT) or LCD display (or touch screen), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections (e.g., user operations) to processor 804 and for controlling cursor movement on display 812. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computing system 800 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the modules described herein refer to logical modules that may be combined with other modules or divided into sub-modules despite their physical organization or storage.

The computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor(s) 804 executing one or more sequences of one or more instructions contained in main memory 806. Such instructions may be read into main memory 806 from another storage medium, such as storage device 810. Execution of the sequences of instructions contained in main memory 806 causes processor(s) 804 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 810. Volatile media includes dynamic memory, such as main memory 806. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may retrieves and executes the instructions. The instructions received by main memory 806 may optionally be stored on storage device 810 either before or after execution by processor 804.

The computer system 800 also includes a communication interface 818 coupled to bus 802. Communication interface 818 provides a two-way data communication coupling to one or more network links that are connected to one or more local networks. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN (or WAN component to communicated with a WAN). Wireless links may also be implemented. In any such implementation, communication interface 818 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world-wide packet data communication network now commonly referred to as the “Internet”. Local network and Internet both use electrical, electromagnetic or optical signals that carry digital data streams. The signals through the various networks and the signals on network link and through communication interface 818, which carry the digital data to and from computer system 800, are example forms of transmission media.

The computer system 800 can send messages and receive data, including program code, through the network(s), network link and communication interface 818. In the Internet example, a server might transmit a requested code for an application program through the Internet, the ISP, the local network and the communication interface 818.

The received code may be executed by processor 804 as it is received, and/or stored in storage device 810, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process steps may be omitted in some implementations. The methods and processes described herein are also not limited to any particular sequence, and the steps or states relating thereto can be performed in other sequences that are appropriate. For example, described steps or states may be performed in an order other than that specifically disclosed, or multiple steps or states may be combined in a single step or state. The example steps or states may be performed in serial, in parallel, or in some other manner. Steps or states may be added to or removed from the disclosed example embodiments. The example systems and components described herein may be configured differently than described. For example, elements may be added to, removed from, or rearranged compared to the disclosed example embodiments.

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A computer-implemented method for generating a non-occluded image from a plurality of images that are captured at multiple locations on a plane region parallel to a surface of a target object, each of the plurality of images including the target object and an occluding object that occludes a part of the target object, the plurality of images including first and second images, the method comprising:
performing a feature detection on the first image to obtain keypoints in the first image;
aligning the first image with a reference image using the obtained keypoints in the first image and keypoints in the reference image;
performing the feature detection on the second image to obtain keypoints in the second image;
aligning the second image with the reference image using the obtained keypoints in the second image and keypoints in the reference image; and
performing a pixel fusion on pixels of the aligned first image and pixels of the aligned second image to generate a first fusion image.

2. The method according to claim 1, further comprising:
determining whether or not a feature difference between the first fusion image and the reference image is less than a threshold; and
upon determining the feature difference is less than the threshold, outputting the first fusion image as the non-occluded image.

3. The method according to claim 2, wherein the plurality of images further includes a third image, and the method further comprises, upon determining the feature difference is not less than the threshold:
performing a feature detection of the third image to obtain keypoints in the third image;
aligning the third image with the first fusion image using the obtained keypoints in the third fusion image and keypoints in the first fusion image; and
performing a pixel fusion on pixels of the aligned third image and pixels of the first fusion image to generate a second fusion image.

4. The method according to claim 1, further comprising:
sorting a plurality of aligned images that are aligned with the reference image based on a structure similarity index (SSIM); and
selecting two or more of the aligned images in a descending order of the SSIM, the two or more of the aligned images including the first image and second image, wherein the pixel fusion is performed on pixels of the two or more of the aligned images.

5. The method according to claim 1, wherein the feature detection is performed in accordance with a scale-invariant feature transform (SIFT).

6. The method according to claim 1, wherein the reference image includes a reference object having a same shape as the target object.

7. The method according to claim 1, further comprising:
locating a camera at a first position on the plane region to capture the first image with the camera; and
moving the camera to a second position on the plane region to capture the second image with the camera.

8. The method according to claim 7, wherein the camera is linearly moved along a direction on the plane region.

9. The method according to claim 1, wherein the first image is captured using a first camera located at a first position on the plane region, and the second image is captured using a second camera located at a second position on the plane region.

10. The method according to claim 1, wherein the plurality of images further includes a third image, and the method further comprises:
performing the feature detection on the third image to obtain keypoints in the third image; and
aligning the third image with the reference image using the obtained keypoints in the third image and keypoints in the reference image, wherein
the pixel fusion is performed also on pixels of the aligned third image together with the pixels of the first aligned image and the pixels of the aligned second image to generate the first fusion image.

11. A computer-implemented method for identifying character information on a surface of a target object from a plurality of images that are captured at multiple locations on a plane region parallel to the surface of the target object, each of the plurality of images including the target object, the plurality of images including first and second images, the method comprising:
performing an occlusion detection to determine whether or not at least part of the text information on the surface of the target object in the first image is occluded by an occluding object;
performing the occlusion detection to determine whether or not at least part of the text information on the surface of the target object in the second image is occluded by an occluding object;
upon determining that the character information is occluded in each of the first image and the second image, performing an occlusion removal to generate a non-occluded image at least based on the first image and the second image; and
performing a character recognition on the non-occluded image to identify the character information.

12. The method according to claim 11, wherein the occlusion detection comprises:
performing an character recognition on a target image subjected to the occlusion detection to obtain character information recognizable from the target image; and
collating the obtained character information with reference character strings, wherein
the target image is determined to be occluded when the obtained character information is not matched with any of the reference character strings and determined to be not occluded when the obtained character information is matched with one of the reference character strings.

13. The method according to claim 11, further comprising:
extracting a partial region of the first image corresponding to the target object; and
extracting a partial region of the second image corresponding to the target object, wherein
the occlusion detection is performed with respect to the partial region of the first image and the partial region of the second image.

14. The method according to claim 11, wherein the occlusion removal comprises:
performing a feature detection on the first image to obtain keypoints in the first image;
aligning the first image with a reference image using the obtained keypoints in the first image and keypoints in the reference image;
performing the feature detection on the second image to obtain keypoints in the second image;
aligning the second image with the reference image using the obtained keypoints in the second image and keypoints in the reference image; and
performing a pixel fusion on pixels of the aligned first image and pixels of the aligned second image to generate a first fusion image.

15. The method according to claim 14, wherein the occlusion removal further comprises:
determining whether or not a feature difference between the first fusion image and the reference image is less than a threshold; and
upon determining the feature difference is less than the threshold, outputting the first fusion image as the non-occluded image.

16. The method according to claim 15, wherein the plurality of images further includes a third image, and the occlusion removal further comprises, upon determining the feature difference is not less than the threshold:
performing a feature detection of the third image to obtain keypoints in the third image;
aligning the third image with the first fusion image using the obtained keypoints in the third fusion image and keypoints in the first fusion image; and
performing a pixel fusion on pixels of the aligned third image and pixels of the first fusion image to generate a second fusion image.

17. The method according to claim 14, wherein the feature detection is performed in accordance with a scale-invariant feature transform (SIFT).

18. The method according to claim 14, wherein the reference image includes a reference object having a same shape as the target object.

19. The method according to claim 11, further comprising:
locating a camera at a first position on the plane region to capture the first image with the camera; and
moving the camera to a second position on the plane region to capture the second image with the camera.

20. The method according to claim 11, wherein the first image is captured using a first camera located at a first position on the plane region, and the second image is captured using a second camera located at a second position on the plane region.
